(19) United States
(12) Patent Application Publication
(10) Pub. No.: US 2019/0131832 A1
(43) Pub. Date: May 2, 2019

(54) ENERGY OPTIMIZATION DEVICE

(71) Applicant: Angel Vazquez Hernandez, Ciudad de México (MX)

(72) Inventor: Rodrigo Cesar Ibarra Salinas, Naucalpan (MX)

(21) Appl. No.: 16/163,833

(22) Filed: Oct. 18, 2018

(30) Foreign Application Priority Data
Oct. 31, 2017 (MX) MX/A/2017/013970

(51) Int. Cl. H02K 1/22; H02K 1/02; F04D 13/06; F25B 49/02

(52) U.S. Cl. CPC H02K 1/22; H02K 1/02; F04B 2203/0202; F25B 49/022; F04D 13/06

(57) ABSTRACT

An energy optimization device, which comprises a magnetic circuit composed of a coil and a ferromagnetic core, which achieves an acceleration of charges by means of which said loads are reintroduced back into the network, achieving an effective saving of active power.

### BACKGROUND OF THE INVENTION

### Field of the Invention

The present invention is related to devices for saving energy, and more particularly with an energy optimizing apparatus and voltage conditioner that achieves an effective saving of active power.

### Description of the Related Art

Alternating current electrical devices use energy in a particular way. A part of that energy is actually consumed by the apparatus to perform a job, for example for a pump motor to raise the water to the tank, or to heat the filament of a lamp. This power is known as active power, it is measured in Watts and it is designated with the letter P. Another part of the energy taken from the network is not “spent” by electrical appliances, but the source (electric company) delivers that power energy and the device stores it momentarily and then returns it to the source.

In this way there is an exchange of energy between the source and the device, which on average turns out to be zero, so it does not produce useful work. This form of power is known as reactive power, it only appears when there are reactive components in the circuit (coils or capacitors) and it is the flow of energy temporarily stored in the form of an electric or magnetic field in said elements.

The apparent power (S), is the total power consumed by the load and is the product of the effective values of voltage and intensity. It is obtained as the vector sum of the active and reactive powers and represents the total occupation of the facilities due to the connection of the receiver.

The power factor or cosine of “fi” (Cos<p) represents the value of the angle formed by graphically representing the active power (P) and the apparent power (S), that is, the relationship between the power real work and the total power consumed by the load or the consumer connected to an electrical circuit of alternating current.

The power factor indicates how the electrical energy is used and provides a measure of the efficiency of the device. Engines, and transformers, tend to worsen the power factor (which varies between 0 and 1). Thus, a power factor of 0.8 means that, of the total energy supplied, only 80% is properly used to produce work,—such as operating an appliance.

There are currently several types of energy savers available in the market. The most common type of energy saver has a capacitor to correct the power factor of inductive reactive loads generating a capacitive reactive.

In the domestic sphere, only the so-called active energy consumed, measured in kilowatt hours (kWh), is invoiced. Thus, having a power saver of these characteristics connected to the home's electrical network, plugged into any outlet in the home network, is equivalent to generating capacitive reactive power in the household electrical system, of which it normally exists in lesser measure in the electrical systems, since there is always more inductive reactive in the networks.

The idea behind this type of energy saving devices is that it balances both loads so that there is a much less waste of energy, however, in the domestic sector the reactive energy consumed is not invoiced, and, therefore, is not achieve any savings by installing capacitors.

The capacitors provide part of the reactive power needed by the coils (of an engine, for example). Having a capacitor connected all the time could correct the power factor when there is a fan or an air conditioner running, but it would get worse at the time when there is no motor connected, becoming counterproductive.

Therefore, it would be highly desirable to have an energy saver that can induce the flow of energy stored temporarily in the form of an electric or magnetic field in the windings of the motors or compressors (inductive load) and that can decrease the active power.

In view of the aforementioned need, the applicant developed an energy optimizing apparatus, which achieves an effective saving of active power, improves the quality of current and voltage through the phase shift of the current intensity with respect to the voltage, thus shortening the micro points of the voltage, optimizing them in quality and re-induces the flow of energy temporarily stored in the form of electric or magnetic field in the windings of the motors or compressors (inductive load).

The energy optimizing device of the present invention comprises a magnetic circuit composed of a coil and a ferromagnetic core, which achieves an acceleration of charges by means of which said loads are re-introduced back into the network without being it is necessary to use any type of turn shadow, blind turn, any type of electronics or other external device.

### OBJECTIVES OF THE INVENTION

It is therefore a principal objective of the present invention to provide an energy optimizing device, which is comprises a magnetic circuit composed of a coil and a ferromagnetic core, which achieves an acceleration of charges by means of which said loads are re-introduced back into the network without being it is necessary to use any type of turn shadow, blind turn, any type of electronics or other external device.

It is another main objective of the present invention to provide an energy optimizer device of the nature described above, which achieves an effective saving of active power.

It is still a main objective of the present invention, provide an energy optimizer device of the nature described above, which improves the quality of current and voltage by offsetting the current intensity with respect to the voltage, thus shortening the micro points of the voltage sine wave, optimizing them in quality.

It is a further object of the present invention to provide an energy optimization device of the nature described above, which induces the flow of energy stored temporarily in the form of an electric or magnetic field in the windings of motors or compressors (inductive load).

These and other objects and advantages of the present invention will become apparent to those of ordinary skill in the art from the following detailed description of the invention.

### BRIEF DESCRIPTION OF THE DRAWINGS

FIG. 1A is a diagram of the work coil of the energy optimizer device of the present invention.

FIG. 1B is a diagram of the control coil of the energy optimizer device of the present invention.

FIG. 2 is a schematic of the energy optimizer device of the present invention.

FIG. 3 shows a connection diagram of the energy optimizer device for a single-phase system.

FIG. 4 is a diagram of a three-phase system showing the connection of an energy optimizer device of the present invention connected to each phase of a three-phase system.

FIG. 5a comprises a sinusoidal graph showing the current offset in relation to the voltage.

FIG. 5b, comprises a sinusoidal graph showing the voltage offset in relation to the current.

FIG. 6 is a copy of the document issued by Tüv Reihnland lberica Inspection, where the product is described.

FIG. 7 is a copy of the document issued by Tüv Reihnland lberica Inspection, where the test procedure is described

FIG. 8 is a copy of the document issued by Tüv Reihnland lberica Inspection, where the results of the test are described.

### DETAILED DESCRIPTION OF THE INVENTION

The energy optimizing apparatus of the present invention will now be described in accordance with a preferred embodiment thereof and with reference to the accompanying figure, wherein the energy optimization device of the present invention can be used for single-phase and three-phase systems and understands for each phase:

A ferromagnetic core member in the form of a square made of a ferromagnetic material, formed by two secondary members parallel to each other and a first core member and a second core member parallel to each other;

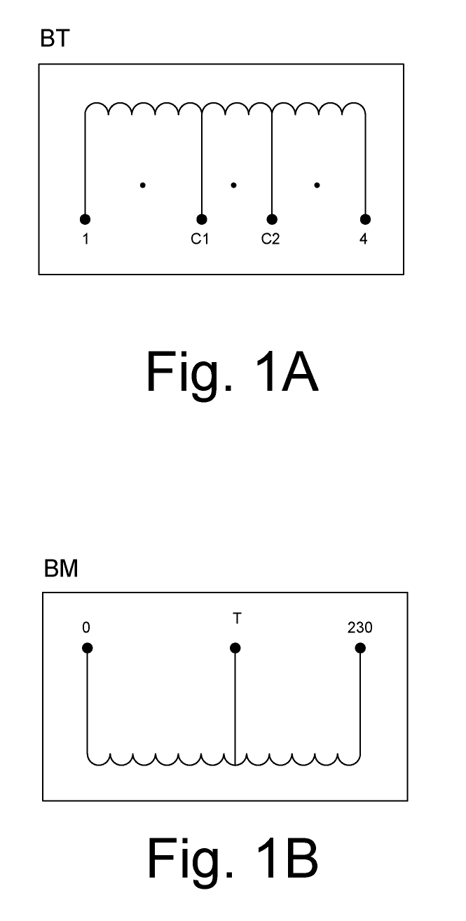

A winding called work coil, composed of one or more work coils, each work coil having an input in phase and an output in the same phase and each work coil surrounding the first core member in a specific longitudinal location thereof, depending on the input voltage, where the selected work coil depends on the input voltage, it is connected in series with the corresponding phase and has the function of generating a first magnetic field in the ferromagnetic core called the self-induced field. FIG. 1A shows a diagram of the work coil (BT), where (1) represents the phase current input to the chosen work coil, (4) represents the current output from the work coil to the load in their respective phase and (C1) and (C2) represent the intermediate connections.

A coil called the operating coil, which surrounds the second core member, having a phase input connected in parallel with the phase input of the chosen work coil, an output in the same phase and a neutral tap, where said second coil is energized by the single-phase fixed current, and wherein said second coil generates a fixed electromagnetic field. FIG. 1B shows a diagram of the control coil (BM), where (230), (0) represents the supply input of the supply network in phase and “T” is taken by the corresponding phase, and will depend on the voltage of the supply network of each country or region.

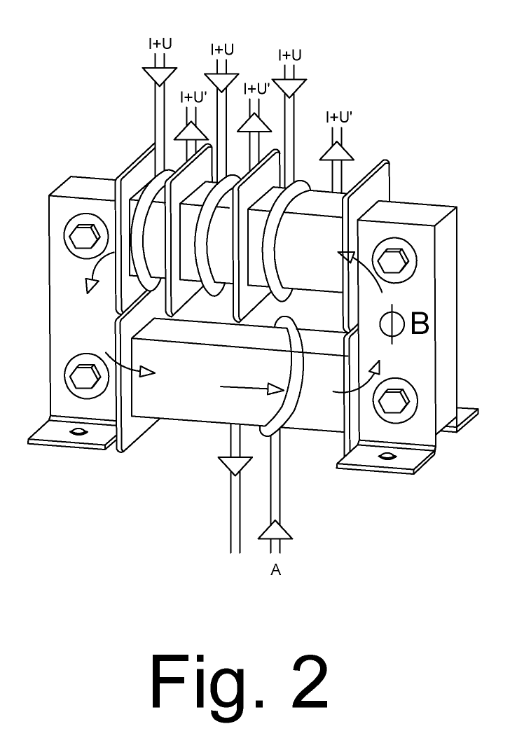

FIG. 2 shows a diagram of a phase of the device of the present invention where 1+U are the supply inputs of the electrical network and 1′+U′ the outputs of each coil to the loads of the installation with the load duly accelerated and optimized. (A) represents phase input of the control coil.

The self-induced field generated by the work coil circulates through the ferromagnetic core and joins with the fixed magnetic field generated by the control coil, which accelerates the self-induced field, absorbing, on the one hand, the parasitic currents, peaks of tension and part of reactive currents, that is to say, clean the sine wave of everything previously exposed. The work coil induces an electromagnetic field that, thanks to the hysteresis cycle, magnetizes the ferromagnetic core until it reaches the point of magnetic saturation. With the core already magnetized with a magnetic load, and the maneuvering coil accelerates said load which will be induced again into the power supply network, wherein said acceleration creates a phase shift and shortening of the current with respect to the voltage.

The voltage peaks, and supplied imperfections caused by the electrical network itself, are stored in the body of the magnetic core, generating a constant and stable magnetic flux. Said magnetic flux advances the subsequent incoming wave when an offset of the intensity with respect to the voltage is created, allowing time for the accelerated loads for the actuating coil to be integrated back into the electrical network by the series connection of the work coil, wherein the work coil charges magnetic flux and the maneuver coil accelerates said load. As a result, a vector offset between intensity and voltage of between 2 and 3 degrees minimum is created. This value will depend on the type of installation and will be lower or higher according to characteristics. For this it is not necessary to use any type of turn shadow, blind turn, electronics or other external device than those mentioned above.

Thanks to said lag shift factor and thanks to the shortening of the vacuum spaces of the micro points of the sinusoidal lines of the voltage, the supply of electrical power is facilitated, given its filtering, to the receivers or loads. With this shortening between the intensity and the voltage, taking advantage of the amount of magnetic flux that is created in the windings of the motors or compressors (inductive load) connected in series to the work coil:

When the ferromagnetic core is magnetized with the first cycle of intensity fed to the work coil, with the consecutive cycle steps, it is possible to accelerate the magnetic flux charges (f), since the core is loaded due to the hysteresis cycle. With this acceleration effect, the accelerated loads are reintroduced back into the connected network, in the same way as if it were a generating plant that raised a few volts to its manufacture to revert to the existing network its production of electricity supply. At the same time the ford spaces and micro points of the voltage sine wave are compacted, thus optimizing its initial state, creating a cleaner sinusoidal wave in its output eliminating possible impurities, parasitic currents, and stabilizing it, giving its output a constant wave favoring the life of the receivers. In addition, thanks to this factor, less losses are obtained for the joule effect and the life of the receivers is lengthened, keeping the voltage value constant and absorbing the possible voltage pikes that the supply companies can supply.

By stabilizing the voltage and with the sum of the charges created, by acceleration and loaded in the ferromagnetic core a decrease in active power is achieved.

The law of ohm reflects the following expression:

P=U*I

, where “U” is voltage, “I” is intensity giving as power product.

Intensity:

There is an input “I₁” that feeds the ferromagnetic core member, creating a magnetic flux (f), which thanks to the hysteresis cycle is magnetized until reaching the point of magnetic saturation. With the second intensity cycle, since it is magnetically primed, the load is accelerated by obtaining lc, charged current, said intensity has been created and is not provided for the supply network. Given this factor, it results in an output intensity different from that of the input: I₂.

I₂=I₁+l_{c}. since lc has been created for the energy optimizing apparatus of the present invention, the resolution would be:

I₂=I₁+i_{c}. giving as final result: l₂>l₁

Voltage:

The sinusoidal line of the voltage is formed of an achievement of ellipses. The energy optimizing apparatus of the present invention shortens the void spaces that exist between point and point, that is, it optimizes the vacuum spaces between the micro points that make up the voltaic sine wave. Since it is reflected in sinusoidal form, it will be appreciated in its measure as a slight numerical reduction (UF). This shortening makes the initial wave become purer and cleaner in its output in accordance with the previously explained. This effect will make the receivers receive a sharper and more stable wave, favoring that they work at a lower temperature and lengthening their life in general.

U2=U1−UF

U2>U1

given the law of ohm, P=U*I

P1=U1*11 in network mode *

P2=U2*12 in optimizer mode **

* Network mode: electricity is provided by the supplying company

* Saving mode: electricity is the one provided by the energy optimizing apparatus of the present invention.

Given that: I2>I1 and U2>U1, will give us a result in active power of: P1>P2.

Being:

P1: primary power of the load

P2: power generated by the magnetic circuit.

The operation of the energy optimization device of the present invention is automatically adapted to the load to which it is connected, being effective in all types of loads, and compatible with all types of installations.

Depending on the type of load, the facilities will act in one way or another.

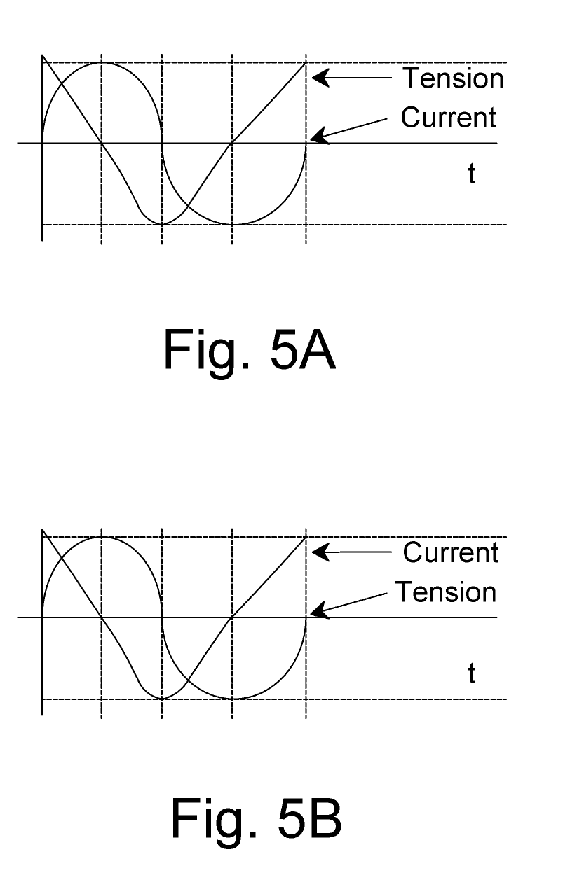

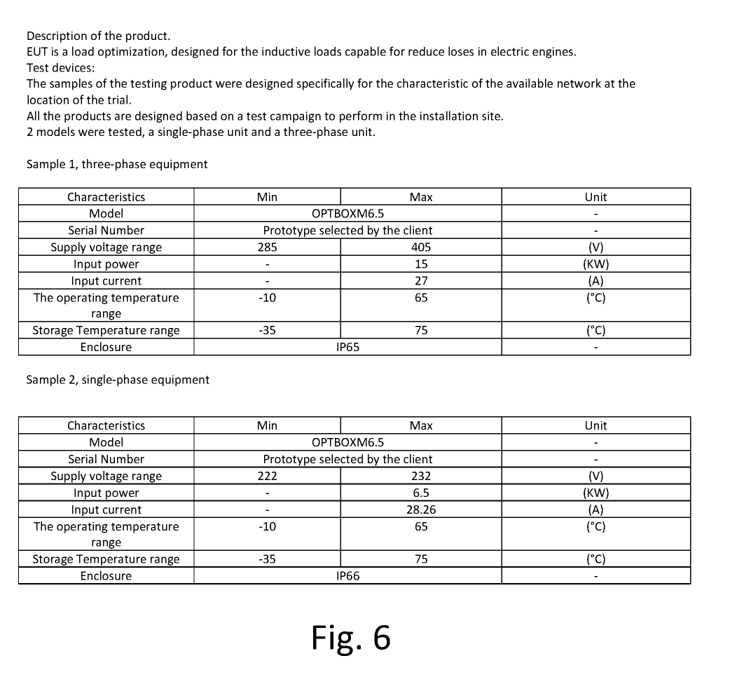

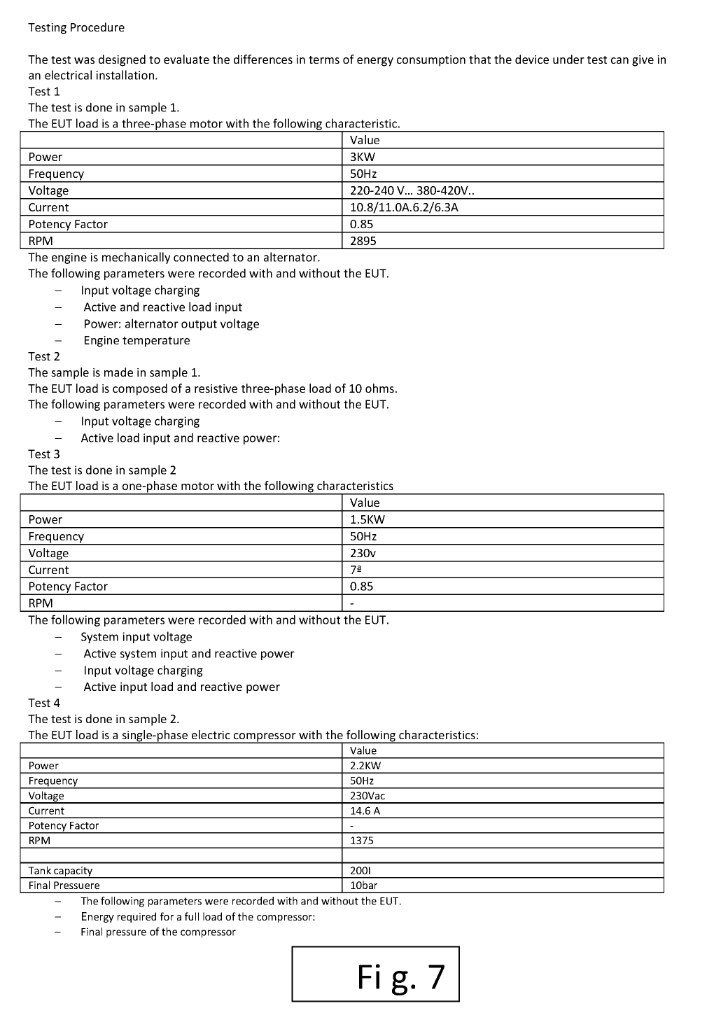

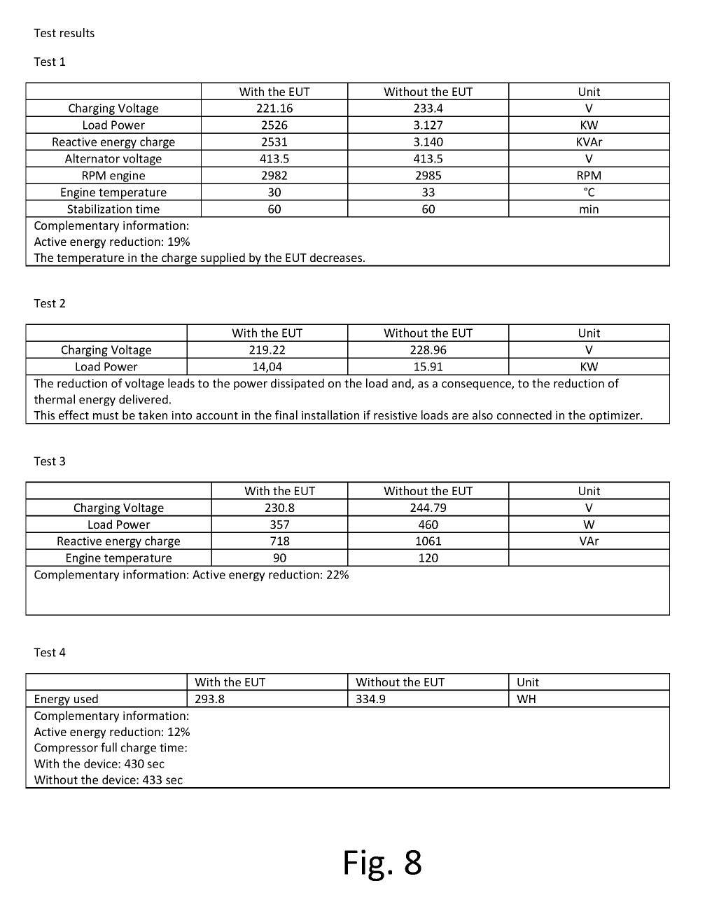

When an inductive current load is connected to an electrical circuit, such as for example motors, the current sinusoid is offset in relation to the voltage, as shown in the graph of FIG. 5A.

When a load of capacitive current is connected to an electrical circuit such as a capacitor, the intensity sinusoid will be offset, but in the opposite direction ahead of the voltage, the comma is shown in the graph of FIG. 5B.

Due to these factors and principles of electrical operation, a greater efficiency for inductive loads is obtained, also highlighting the energy optimization device of the present invention will help to stabilize the excess of voltage that supplies the electrical network, getting to obtain a better operation of the electric receivers.

In the energy optimization device of the present invention, when a vector lag shift of the intensity with respect to the voltage is created, greater efficiency is obtained in inductive loads due to the fact that they stop generating a quantity of magnetic fields allowing the motors, compressors, etc. reuse their own magnetic flux, thus obtaining less losses by joule effect. Contrary to generating or creating something to be able to reuse it, the apparatus of the present invention stops generating a quantity of magnetic fluxes, so that the receivers themselves are fed back with the own flux that they themselves are creating, thus giving rise to an improvement in the performance for less losses by joule effect, optimizing the input voltage, stabilizing it, and thus obtaining a reduction of temperature 3 and 4 degrees in three-phase motors and up to 33 degrees in single-phase.

In resistive loads the performance will be somewhat lower since there are no windings or inductances. The cosine of fi will be 1, so the efficiency percentage will be lower. The principle of operation will be the same, reducing by equal the factors previously determined.

Due to these factors, a greater efficiency for inductive loads is obtained, also highlighting the energy conditioning apparatus of the present invention will help to stabilize the excess voltage supplied by the electrical network, getting to obtain a better operation of the electric receivers.

Although there are no single capacitive facilities as such, the capacitors are used to reuse reactive power (capacitor banks) which is a totally different saving format and unrelated to the energy optimization device of the present invention, although perfectly compatible since said capacitors are connected in parallel and their function is to reuse the reactive energy and the active energy optimization device of the present invention is connected in series with the load, which provides time for said magnetic flux to be re-induced, thereby they get less losses by Joule effect.

The device of the present invention can also be connected to mixed, inductive and resistive mixed current loads.

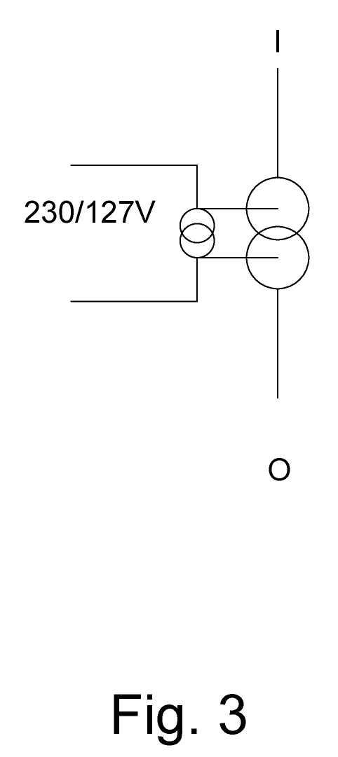

FIG. 3 shows a connection diagram of the energy optimizing apparatus for a single-phase system, where the input of the chosen work coil (I) is connected to the power supply of the supply network and the output (O) is connected in series with the charges. In the same way, the input of the control coil is connected in parallel with the power supply of the supply network (230/127V) and its neutral connection is connected to the neutral conductor.

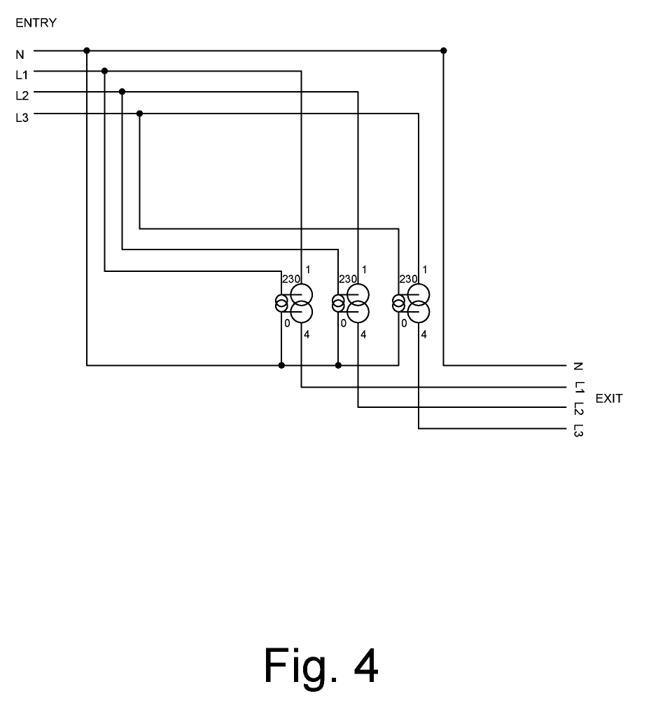

For three-phase systems, each phase has an independent device, connected in the manner previously described for single-phase systems, having in common a connection to the neutral conductor, such as is shown in FIG. 4, where (L1), (L2), (L3) represents the corresponding phase, (N) represents the neutral conductor, (1) represents the current input of each phase to the chosen work coil, (4) represents the current output of each work coil to the load in their respective phase and (230) and (0) represent the input in parallel and the corresponding output in phase to the control coil.

Functional Tests

The following are tests carried out by Tüv Reihnland lberica Inspection to evaluate the differences in terms of reduction of active power consumed using the apparatus of the present invention.

The tests allowed to measure the electrical parameters in a laboratory simulating four different scenarios related to energy consumption in domestic and industrial facilities.

In said tests the product of the present invention showed positive results concerning active power reduction using the apparatus of the present invention as described in each test.

Summary of results of test report 28110351.001 of compliance record CN No. 28300445.002

| | |
|---|---|
| Test 1 (Three-phase) | Active power reduction: 19% |
| Load = Motor | |
| Test 2 (three-phase) | Normal functioning evidenced |
| Load = resistance | Reduction of thermal energy |
| | through the reduction of |
| | dissipated energy due to |
| | voltage reduction |
| | Voltage optimization = 5.72% |
| | Active power reduction = |
| | 11.75% |
| Test 3 (single phase) | Active power reduction: 22% |
| Load = motor | |
| Test 4 (single phase) | Active power reduction: 12% |
| Load = electric compressor | |

The temperature of the consumers installed in the test circuit does not increase in normal function and measurement. In engines, a reduction in temperature was measured.

The reduction of the energy consumption allows to evaluate the reduction of the CO2 footprint according to the applicable calculations.

The engine RPM did not differ with the use of the energy optimizer, it was measured with and without energy saving and the measured RPM was exactly the same.

1-8. (canceled)

9. An energy optimization device for use in single-phase or three-phase alternating current electric networks, who can be connected to inductive, resistive, capacitive current loads or mixed current loads and comprising: a ferromagnetic core member in the form of a square made of a ferromagnetic material, formed by two secondary members parallel to each other and a first core member and a second core member parallel to each other; a winding called work winding, which surrounds the first core member, said first work coil having a power input of the supply network in phase and an output in the same phase, and additionally having one or more intermediate connections in several points of the coil who can be chosen to be connected with the mains supply depending on the input voltage; a coil called the control coil that surrounds the second core member, counting on a supply input of the supply network in phase and a neutral outlet, being able to connect its phase in the appropriate outlet depending on the input voltage of each country or region; where in single-phase systems, the input of the chosen work coil is connected to the power supply of the supply network and the output is connected in series with the loads; where the input of the control coil is connected to the supply of the supply network and its neutral connection is connected to a neutral conductor. Wherein the work coil has the function of generating a self-induced field with a single-phase current, priming said ferromagnetic core with a magnetic flux load; and where the control coil is excited by a fixed monobasic current and generates a fixed electromagnetic field, accelerating the charge of the ferromagnetic core creating a phase shift and shortening of the voltage intensity, allowing time for the accelerated loads to be integrated again in the electricity network.

10. An energy optimization device according to claim 9, wherein in three-phase systems each phase has an independent apparatus, having in common a connection to the neutral conductor.

11. An energy optimization device according to claim 9, wherein the self-induced field generated by the work coil flows through the ferromagnetic core and joins with the fixed magnetic field generated by the operating coil, which regulates the self-induced field, absorbing parasitic currents, voltage peaks and part of reactive currents.

12. An energy optimization device according to claim 9, wherein: voltage peaks, which are caused by the electrical network itself, are stored in the body of the magnetic core, generating an electrical voltage that delays the subsequent incoming wave when a voltage is created lag of the intensity with respect to the voltage, allowing time for the accelerated loads to be integrated into the electrical network again.

13. An energy optimization device according to claim 9, wherein: a vector lag is created between voltage and voltage of between 2 and 3 degrees, shortening the vacuum spaces of the micro points of the sinusoidal lines, facilitating the input, given its filtering, to the receivers or charges, and where with this shortening between the intensity and the voltage, the amount of magnetic flux created in windings of inductive loads connected in series to the working winding is used, thus obtaining less losses by Joule effect since there is a reuse of the magnetic field created by the receptors themselves.

14. An energy optimizing apparatus according to claim 9, wherein the flux is reintroduced into the network by accelerating the magnetic flux charges, by magnetization of the ferromagnetic core when charged due to the hysteresis cycle.

15. A method to save energy for use in single-phase or three-phase alternating current electric networks to which inductive, capacitive, resistive current loads or mixed current loads are connected, wherein said method comprises the steps of:
a) generating a self-induced field in a ferromagnetic core member having a first core portion and a second core portion, by a first coil, energized by a single-phase current, surrounding the first core portion, to prime said core ferromagnetic core with a magnetic flux load; and
b) accelerating the charging of the ferromagnetic core by means of a second coil, excited by a single-phase current, which surrounds the second core portion of creating a phase shift and shortening of the intensity with respect to the voltage, in this way:
giving time for the accelerated loads to be integrated into the electricity grid again, thus achieving energy savings;
adjusting the self-induced field that circulates through the ferromagnetic core generated by the first work coil with the fixed magnetic field generated by the control coil, which regulates the self-induced field, to absorb parasitic currents, voltage spikes and part of reactive currents; and
storing the voltage speaks, which causes the electrical network itself in the body of the magnetic core, generating an electrical voltage that advances the subsequent incoming wave when creating a lag of the intensity with respect to the voltage, allowing time for the accelerated loads to be integrated again in the electricity network.
